(19) United States
(12) Patent Application Publication
(10) Pub. No.: US 2020/0351447 A1
(43) Pub. Date: Nov. 5, 2020

(54) METHOD AND APPARATUS FOR AUGMENTING IMAGES CAPTURED USING EYEWEAR FOR ACQUIRING AN IMAGE PRESENTED TO A VIEWER ON AN EXTERNAL DEVICE

(71) Applicants: Nicholas Jamie Marston, Sheffield (GB); Benjamin David Wyatt, Longnor (GB)

(72) Inventors: Nicholas Jamie Marston, Sheffield (GB); Benjamin David Wyatt, Longnor (GB)

(21) Appl. No.: 16/402,063

(22) Filed: May 2, 2019

(51) Int. Cl. H04N 5/232; H04N 5/225; H04N 5/272; G06T 7/246; G06T 7/90; G06T 11/00

(52) U.S. Cl. CPC H04N 5/23299; H04N 5/2253; H04N 5/272; G06T 2207/10016; G06T 7/90; G06T 11/00; G06T 7/246

(57) ABSTRACT

A method, apparatus and system to provide enhancements to body worn devices, such as but not limited to helmets, headwear and eyewear, for acquiring an image where a camera's position and orientation is adjustable relative to the users desired line of sight and the captured image is viewed on an external remote electronic device, such as but not limited to, a handheld computing device (e.g., a smart phone) or a wearable electronic device (e.g., a smart watch) by means of a communication means, such as but not limited to, wireless communication. The present technology can utilize image recognition logic configured or configurable to analyze image data representing a real world scene, to recognize and analyze particular shapes and/or colors, and to incorporate as required an additional image into the real world scene as seen by the user by means of augmented reality.

### BACKGROUND

### Technical Field

The present technology relates to an augmenting image method, apparatus and system, for use in connection with capturing a video or image by an eyewear mounted camera and augmenting the video or image for presenting to a viewer utilizing an external display.

### Background Description

Presently available digital video recording (DVR) glasses either comprise a fixed camera position, or in the case of the present technology the camera position and orientation is adjustable relative to the users desired line of sight either using trial and error, or according to the expected angle of gaze relative to the head for a particular activity. Once the desired camera position and orientation is found a locking member, which can be actuated selectively, can be used to secure the camera body in position relative to the head and eye orientation of the wearer to produce a fixed camera angle representing a chosen line of sight.

Known DVR glasses are available with a mini DVR camera lens placed immediately above the apex of the nose bridge in the center of the glasses frame. Several problems were found with this type of unit. The first being that from the camera position, in relation to the right eye (of a right handed shooter) and the barrel, down which the right eye aligns to the target, the camera projects to the right of the gun. The resulting video does not film the gun barrel nor the target. The converse is true for a left hand shooter. To re-align the camera in its statutory position does not produce the desired result.

While the above-described devices fulfill their respective, particular objectives and requirements, the aforementioned patents do not describe an augmenting image method, apparatus and system that allows for augmenting images captured using an eyewear mounted camera for presenting to a viewer on an external display.

Therefore, a need exists for a new and novel augmenting image method, apparatus and system that can be used for augmenting images captured using eyewear for acquiring an image presented to a viewer on an external display. In this regard, the present technology substantially fulfills this need. In this respect, the augmenting image method, apparatus and system according to the present technology substantially departs from the conventional concepts and designs of the prior art, and in doing so provides an apparatus primarily developed for the purpose of augmenting images captured using eyewear for acquiring an image presented to a viewer on an external display.

### BRIEF SUMMARY OF THE PRESENT TECHNOLOGY

In view of the foregoing disadvantages inherent in the known types of video processing systems, the present technology provides a novel augmenting image method, apparatus and system, and overcomes the above-mentioned disadvantages and drawbacks of the prior art. As such, the general purpose of the present technology, which will be described subsequently in greater detail, is to provide a new and novel augmenting image method, apparatus and system and method which has all the advantages of the prior art mentioned heretofore and many novel features that result in a augmenting image method, apparatus and system which is not anticipated, rendered obvious, suggested, or even implied by the prior art, either alone or in any combination thereof.

According to one aspect of the present technology, the present technology essentially includes a video capture system for augmenting of live video data in real time. The system can include a camera, a mounting rail and a universal multi-axis adjustable joint. The camera can be configured or configurable to capture video or images of a real world scene. The mounting rail can be associated with an apparatus wearable by a user. The universal multi-axis adjustable joint can be attachable to the camera and the mounting rail. The adjustable joint can be configured to adjust a position and orientation of a camera axis of the camera relative to a frame of the apparatus about a vertical and horizontal axis. The adjustable joint can be configured to fix the camera in a desired position and orientation such that the camera axis and field of view of the camera is alignable with a desired line of sight of the user.

According to another aspect of the present technology, the present technology can essentially be a video capture system for augmenting of live video data in real time. The system can include a wearable assembly and an electronic device. The wearable assembly can include: a camera configured or configurable to capture video or images of a real world scene; a mounting rail associated with an apparatus wearable by a user; and a universal multi-axis adjustable joint attachable to the camera and the mounting rail. The adjustable joint can be configured to adjust a position and orientation of a camera axis of the camera relative to a frame of the apparatus about a vertical and horizontal axis. The adjustable joint can be configured to fix the camera in a desired position and orientation such that the camera axis and field of view of the camera is alignable with a desired line of sight of the user. The electronic device can be in communication with the camera to receive the captured video or images. The electronic device can include at least one processing unit configured to: receive the captured video or images from the camera; process the captured video or images to add virtual objects to create an augmented video or image; and display the augmented video or image on a display of the electronic device or in communication with the electronic device.

According to another aspect of the present technology, the present technology can essentially be a wearable camera system consisting of eyewear for acquiring an image where the eyewear apparatus comprises a frame arranged to be supported on a wearer's head to extend across the head; and at least one front facing camera mounted to the frame by means of a lateral rail mount together with a least one universal tensioned three axis adjustable joint so as to allow the position and orientation of the camera axis relative to the frame and thus the wearers head to be adjustable about a vertical and horizontal axis, whereby the camera can be fixed in a particular desired position and orientation such that the camera axis and field of view can be aligned with the desired line of sight of the wearer; additionally the wearable camera system to incorporate a means of digitally recording and/or transmitting line of sight video linked to a wireless communication transmitter thus enabling the user to view the images captured by the camera sensor on a suitable external wireless communication enabled remote electronic device, for example a handheld computing device (e.g., a smart phone) or a wearable electronic device (e.g., a smart watch) by means of a software interface or application; said software interface having the capability of object detection and tracking using color, feature, temperature variation, and/or motion to detect one or more specified heat signatures, colors or shapes and to track the movement of an object or target and said software interface also having the capability to provide Augmented reality (AR) to enrich a user's real environment by adding spatially aligned virtual objects (3D models, 2D textures, textual annotations, etc.) superimposed over the top of real world video images captured by the camera for the purpose of enhancing the users line of sight analysis either via wireless transmission to one or more users, or during replay in real time or altered speed.

According to yet another aspect of the present technology, the present technology can include a method for augmenting of live video data in real time using a video capture system. The method can include the steps of adjusting a position and orientation of a camera axis of a camera relative to a frame of an apparatus about a vertical and horizontal axis utilizing a universal multi-axis adjustable joint attachable to the camera and a mounting rail associated with the apparatus wearable by the user. Fixing the camera in a desired position and orientation such that the camera axis and field of view of the camera is alignable with a desired line of sight of the user. Capturing a video or images of real world scene with the camera. Communicating the captured video or images to an electronic device. Processing the captured video or images to add virtual objects to create an augmented video or image. Displaying the augmented video or image on a display of the electronic device or in communication with the electronic device.

There has thus been outlined, rather broadly, features of the present technology in order that the detailed description thereof that follows may be better understood and in order that the present contribution to the art may be better appreciated.

In some embodiments, the apparatus can be eyewear including a frame arranged to be supported on a head of the user and to extend across the head.\

In some embodiments, the camera can be a front facing camera mounted to the mounting rail that is associated with the frame.

Some embodiments of the present technology can include a mounting member attachable to the mounting rail and the adjustable joint.

In some embodiments, the adjustable joint can include a first socket configured to receive a ball of the camera, and a second socket configured to receive a ball of the mounting member.

In some embodiments, the adjustable joint can be a pair of linkage arms in space apart relation to define the first socket and the second socket when the linkage arms are assembled.

In some embodiments, the linkage arms can be secured to the ball of the camera and the ball of the mounting member by a fastener engageable with at least one of the linkage arms.

In some embodiments, the processing unit can be further configured to detect and track a real world object in the captured video or images by detecting and tracking a color applied to a particular element of the real world object such utilizing color based object detection and tracking software.

In some embodiments, the software interface or application can be optionally incorporated into the eyewear either in addition to or as an alternative to the suitable external wireless communication enabled remote electronic device.

In some embodiments, the software interface can be designed to selectably overlay the captured video images viewed on the external wireless communication enabled remote electronic device with digitally generated images comprising at least one vertical line and at least one horizontal line plus an array of dots or circles in order to provide the user with specific points of reference in the style of a reticle whereby the user can then calibrate the desired position and orientation of the camera sensor relative to their head position combined with the position and orientation of any device the user wishes to focus the camera sensor upon relative to the augmented reality objects visible on the screen of the remote electronic device.

In some embodiments, the software interface or application can be designed to selectably overlay the captured video images viewed on an external wireless communication enabled remote electronic device with digitally generated image tracking based on the color or shape detection of a selected element of the video thus captured, specifically the sights of a weapon.

In some embodiments, the software interface or application can be designed to selectably overlay the captured video images viewed on the external wireless communication enabled remote electronic device with digitally generated image tracking based on the color or shape detection of a specific target.

In some embodiments, the software interface or application can be designed to selectably overlay the captured video images viewed on the external wireless communication enabled remote electronic device with digitally generated image tracking based on color, shape or other form of object detection and tracking software focused on the detection and tracking of a projectile, and with the option of an additional algorithm designed to take account of the speed of the projectile together with known flight characteristics in order to demonstrate the trajectory of the projectile relative to a moving target on a frame by frame basis.

In some embodiments, the software interface or application can be designed to detect and recognize particular objects or events which might be too fast or too complex to be detected by the human eye alone, and to then alert the user or a third party observer by means of audible, vibration or visual alert either in real time or by means of wireless transmission or recording and playback.

In some embodiments, the software interface or application can be designed to selectably overlay the captured video images with augmented reality to enrich a user's real environment by adding spatially aligned virtual objects (3D models, 2D textures, textual annotations, etc.) superimposed over the top of real world video images and where the resulting augmented video feed is projected in front of one or both eyes of the user in real time allowing them an enhanced reality perspective of the target.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology.

It is another object of the present technology to provide a new and novel augmenting image method, apparatus and system that may be easily and efficiently manufactured and marketed.

An even further object of the present technology is to provide a new and novel augmenting image method, apparatus and system that has a low cost of manufacture with regard to both materials and labor, and which accordingly is then susceptible of low prices of sale to the consuming public, thereby making such augmenting image method, apparatus and system economically available to the buying public.

Still another object of the present technology is to provide a new augmenting image method, apparatus and system that provides in the apparatuses and methods of the prior art some of the advantages thereof, while simultaneously overcoming some of the disadvantages normally associated therewith.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology.

### BRIEF DESCRIPTION OF THE DRAWINGS

The present technology will be better understood and objects other than those set forth above will become apparent when consideration is given to the following detailed description thereof. Such description makes reference to the annexed drawings wherein:

FIG. 1 is a front plane view of an embodiment of the augmenting image system constructed in accordance with the principles of the present technology, with the phantom lines depicting environmental structure and forming no part of the claimed present technology.

FIG. 2 is a side view of the adjustable linkage arm of the present technology with the camera in multiple positions.

FIG. 3 is a top elevational view of the adjustable linkage arms of the present technology with the camera in multiple positions.

FIGS. 4a to 4c are schematic views of a wearer aiming at a target with the wearers head and/or camera in multiple positions.

FIG. 5 is a front schematic view of the user holding and/or using the electronic device of the present technology.

FIG. 6 is a front schematic view of a live video stream on the electronic device of a point of view of the wearer.

FIG. 7 is a perspective view of the wearer adjusting the camera in relation to the eyewear.

FIG. 8 is a perspective view of locking the camera in a desired position.

FIG. 9 is a block diagram of various components of the eyewear and electronic device.

FIG. 10 is a block diagram of various method or process steps of the present technology.

FIG. 11 illustrates an exemplary electronic computing device that may be used to implement an embodiment of the present technology.

FIGS. 12a to 12c are schematic views of the electronic device displaying the real world image along, with a virtual track line of movement of the tracked object, and with the track line alone.

The same reference numerals refer to the same parts throughout the various figures.

### DETAILED DESCRIPTION OF THE PRESENT TECHNOLOGY

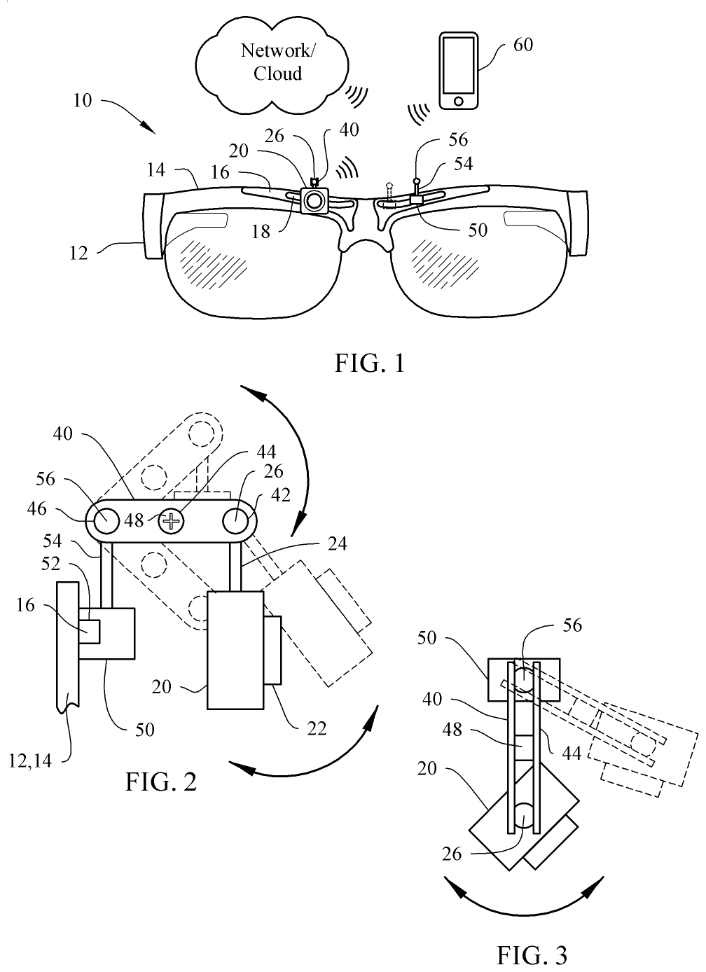

Referring now to the drawings, and particularly to FIGS. 1-12c, an embodiment of the augmenting image method, apparatus and system of the present technology is shown and generally designated by the reference numeral 10.

The present technology relates to a method, apparatus and system to provide enhancements to body worn devices, such as but not limited to helmets, headwear and eyewear, for acquiring an image where a camera's position and orientation is adjustable relative to the users desired line of sight and the captured image is viewed on an external remote electronic device, such as but not limited to, a handheld computing device (e.g., a smart phone) or a wearable electronic device (e.g., a smart watch) by means of a communication means, such as but not limited to, wireless communication. The present technology can utilize image recognition logic configured or configurable to analyze image data representing a real world scene, to recognize and analyze particular shapes and/or colors, and to incorporate as required an additional image into the real world scene as seen by the user by means of augmented reality.

The term augmented reality (AR) can be associated as an interactive experience of a real-world environment where the objects that reside in the real-world are “augmented” by computer-generated perceptual information, sometimes across multiple sensory modalities, including visual, auditory, haptic, somatosensory, and olfactory.

The use of image recognition logic is known art in relation to fixed security cameras, and the use of AR is known art in relation to portable devices configured to provide an augmented reality experience, however the present technology incorporates the use of image recognition logic be it object, color, heat or movement detection into wearable eyewear for acquiring an image where the camera position and orientation is adjustable relative to the users desired specific line of sight, together with the option of AR to enrich a user's perception of the real environment.

In FIG. 1, a new and novel augmenting image method, apparatus and system 10 of the present technology for augmenting images captured using eyewear 12 for acquiring an image presented to a viewer on an external display 60 is illustrated and will be described. The augmenting image method, apparatus and system 10 can include a camera 20 worn on the body, or attached to or integral with an object worn on the body. The camera 20 is configured to receive, capture and/or record a real world scene or any remote video feed, while the external electronic device or display 60 is configured to receive the video feed from the camera 20.

In the exemplary, the present technology can utilize eyewear 12 featuring a frame 14, one or more mounting members 16 positioned on the frame 14, and one or more mounting rails 18. The eyewear 12 is capable of being worn on the head of a user near or juxtaposition to an eye of the wearer/user.

The camera 20 is adjustably and removably secured to the eyewear 12. The camera can include a fixed or adjustable lens 22, a post 24 extending from a camera housing, and a ball 26 located at a free end of the post 24.

A universal three axis adjustable joint 40 that can include a pair of linkage arms 40, can be utilized to mechanically link the camera 20 to a mounting member 50. The linkage arms feature a plurality of holes 42, 44, 46, with a first hole 42 configured to partially receive the ball 26 when placed therebetween. A tightening fastener or screw 48 is engageable with a second hole 44 of each of the linkage arms 40, allowing the two linkage arms 40 to be brought together, thereby squeezing or clamping against the ball 26 therebetween. This consequently will fix or lock the camera 20 in a desired position and orientation. Loosening the screw 48 removes the clamping force against the ball 26, thereby allowing the camera to move, rotate and/or swivel freely.

The mounting member 50 can define a channel or groove 52 configured to slidably receive the mounting rail 18 of the eyewear 12. The mounting member 50 further includes a post 54 extending therefrom, and a ball 56 located at a free end of the post 54. The ball 56 is configured to be partially received in a third hole 46 of the linkage arms 40. As described above, tightening the screw 48 will fix or lock the linkage arms 40 in a desired position and orientation. Loosening the screw 48 removes the clamping force against the ball 56, thereby allowing the linkage arms 40 and camera b to move, rotate and/or swivel freely.

It can be appreciated that the balls 26, 56 when partially received in their respective holes 42, 46, generally form a ball and socket joint. Consequently allowing multiple degrees of freedom of the camera 20, as best illustrated in FIGS. 2 and 3. For example, the camera 20 and linkage arms 40 can be swiveled in the vertical and horizontal (rotational) direction about the mounting member ball 56, and the camera 20 can be further swiveled in the vertical and horizontal (rotational) direction about the camera ball 26.

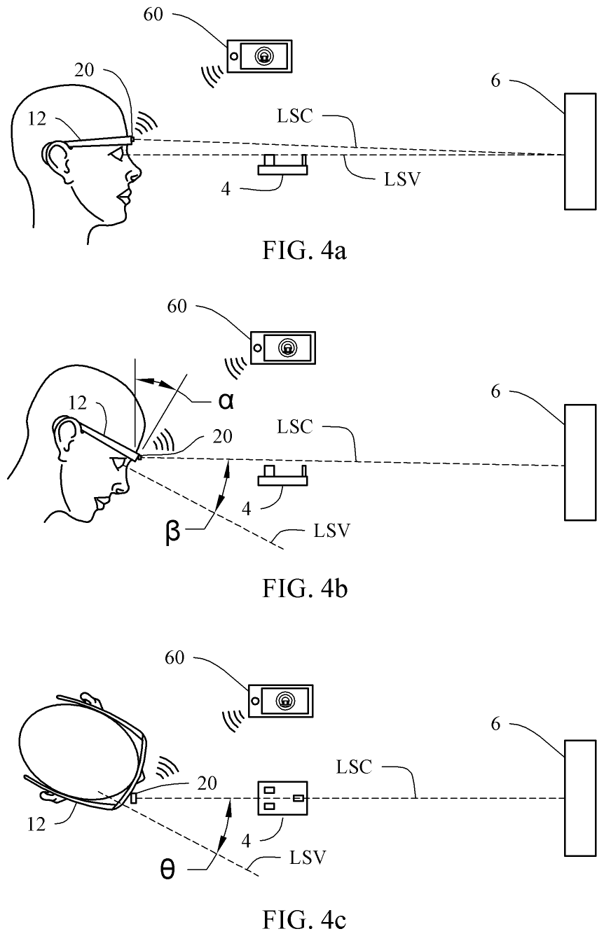

Referring to FIGS. 4a-4c, the present technology can be utilized to provide augmented reality video or images to the external display 60 even when the wearer of the eyewear 12 has a line of sight LSV not in the direction of a target 6. The camera 20 can effectively replicate the angle of the wearer's eye or the line of sight of the viewer LSV aiming a gun sight 4 at the center of a target 6.

It can be appreciated that by adjust the camera line of sight LSC, the wearer can have a different viewing line of sight LSV, even one not directed to the target 6, and still see the target 6 by way of the display 60.

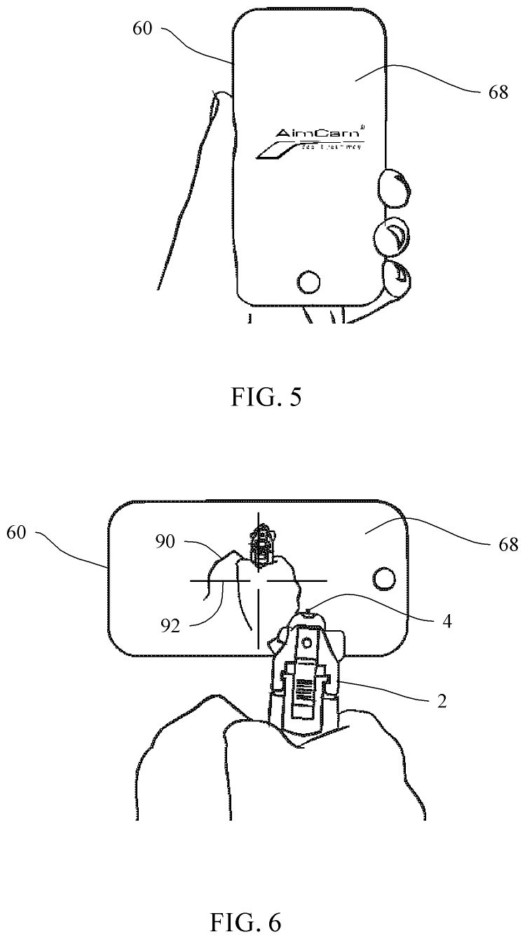

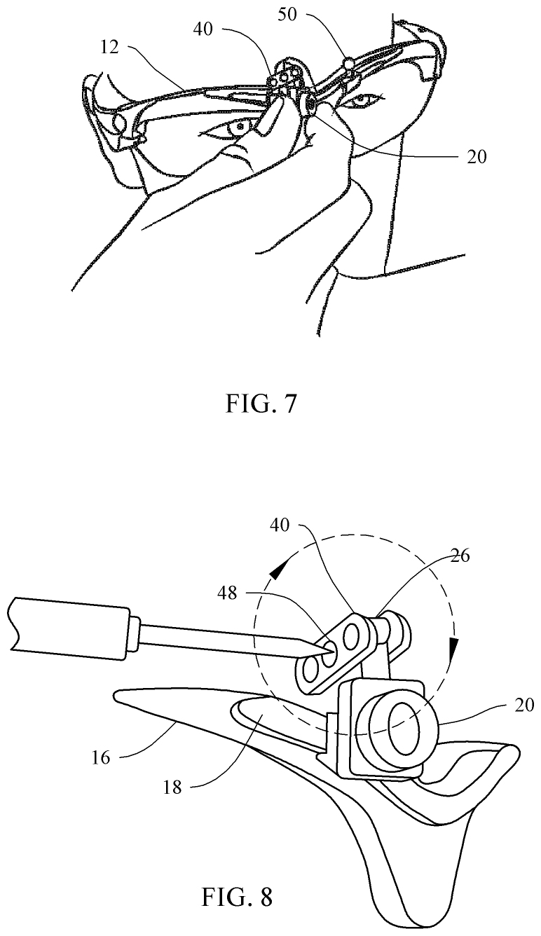

In one possible use, a user would open or connect to application software utilizing the electric device 60, as best illustrated in FIG. 5. The camera 20 is activated to capture a live video stream of a real world scene in the camera line of sight LSC. The live video stream is transmitted to the electric device 60 and displayed on its display 68 via a graphical user interface (GUI), as best illustrated in FIG. 6. The user can adjust the camera line of sight LSC by moving or swiveling the camera 20 utilizing the linkage arms 40 and/or the mounting member 50, as best illustrated in FIG. 7. When the camera line of sight LSC is reached, the user can lock the camera 20 in position by tightening the screw 48, as best illustrated in FIG. 8.

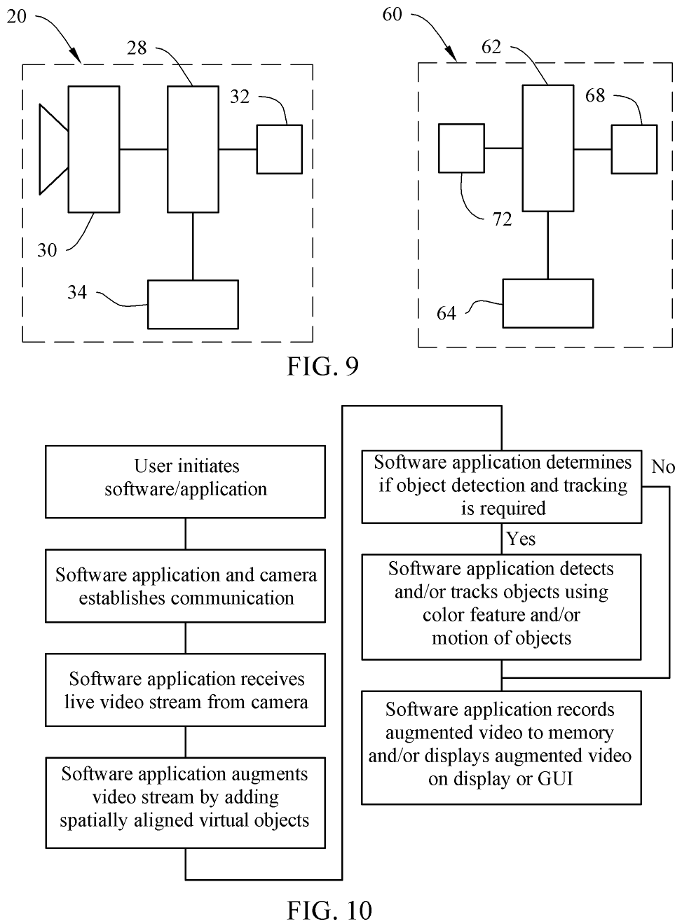

Referring to FIG. 9, the camera 20 can include an image processor or processing unit 28, a camera sensor 30 (for example but not limited to, charged coupled device (CCD) or complementary metal-oxide-semiconductor (CMOS)), a storage or memory unit 34, and a network or wireless interface device 32. It can be appreciated that the camera 20 can be any device capable of capturing images and/or video, and can be associated or integrated with a microphone. The processing unit 28 is in operable communication with the camera sensor 30, the memory unit 34 and/or the network or wireless interface device 32.

The electronic device 60 can include an image processor or processing unit 62, a storage or memory unit 64, a display 68 and a network or wireless interface device 72. The processing unit 62 receives the raw video data from the camera 20, processes the raw video data in real time in possible accordance with at least one algorithm, and then records output/final video recording data in the memory unit 64 and/or displays the output/final video recording data in the display unit 68.

FIG. 10 illustrates exemplary steps associated with utilization of the present technology, wherein a user would initiate software/application on the electronic device. Communication is established between the electronic device and the camera, which is capable of communicating a video feed or stream from the camera to the electronic device. The software application receives live video stream or feed from the camera. The software application then augments the live video stream or feed with spatially aligned virtual objects designated by the user via an input step. The software application then records the augmented video to memory and/or displays the augmented video on the display associated with the electronic device or in communication with the software application or electronic device.

The objective of the present technology is to enhance what can be seen in real time with the human eye with analysis by means utilizing image recognition logic either embedded into the wearable device 12 or external remote electronic device 60 and the provision of AR to enrich a user's perception of the real environment by adding spatially aligned virtual objects (3D models, 2D textures, textual annotations, etc.) superimposed over the top of real world video images captured by the camera sensor 30, and projected onto a user's visual display 60 either in real time or via recording and playback, or by providing other forms of alerts such as audio or vibration alerts related to particular predetermined events that might not otherwise be perceived by the human eye alone.

In the exemplary, when applied to eyewear 12 for acquiring an image, such as but not limited to, a pair of glasses worn by a shooter of moving or static targets, the present technology can be designed to enhance the ability of the user to calibrate the camera sensor 30 to their chosen line of sight LSC, for the user to better perceive and take account of lead when aiming at a moving target and also to better visually analyze the effectiveness of a particular point of aim and the resulting shot in order to provide enhanced visual feedback to the user and thereby improve performance.

It can be appreciated that the present technology can be implemented in numerous ways, including as a method, a system, computer readable media or a device. Several inventive embodiments of the present technology are described below.

In one embodiment, the camera image can be transmitted to the external remote electronic device 60 by means of wireless communication. The external remote electronic device 60 can be equipped with a suitable software interface or application. The software interface designed or configurable to enhance the user experience and the visual analysis of performance, having both the facility to provide augmented reality to enrich a user's real environment by adding spatially aligned virtual objects (3D models, 2D textures, textual annotations, etc.) superimposed over the top of real world video images captured by the camera sensor 30, and also having the optional capability of object detection and tracking using color feature and/or motion to detect one or more specified colors or shapes and to track the movement of an object or target.

In another embodiment, the eyewear 12 itself can contain the facility to provide augmented reality to enrich a user's real environment by adding spatially aligned virtual objects (3D models, 2D textures, textual annotations, etc.) superimposed over the top of real world video images captured by the camera 20, and also having the optional capability of object detection and tracking using color feature and/or motion to detect one or more specified colors or shapes and to track the movement of the target.

In yet another embodiment, the augmented reality logic can be designed or configurable to generate a digital image in the style of a reticle 92 with which to calibrate the position and orientation of the camera relative to the users desired line of sight, as best illustrated in FIG. 6. In this embodiment one or more vertical lines and one or more horizontal lines along with optional dots or circles would be displayed as required superimposed over the video images 90 captured by the camera in order to provide for the user specific points of reference acting as a guide to adjust the camera whereby the user can then calibrate the position and orientation of the camera sensor relative to their head position and orientation and the position and orientation of any device the user wishes to focus the camera sensor upon allowing them to place the desired object, such as a gun 2, in the center of the camera view, with their preferred camera orientation across the object.

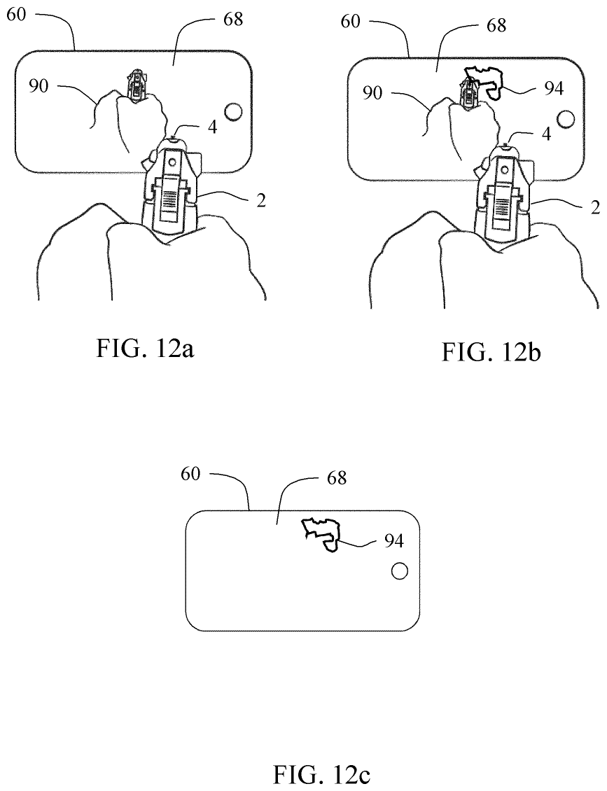

In yet another embodiment of the present technology, the object or weapon 2 being aimed can be selectively marked with a color applied to a particular element of the device such as the sights 4 of a pistol rifle or shotgun in order to make it detectable and trackable by color based object detection and tracking software. Once reviewed in either real time or slow motion the user will be able to see, by a virtual track line 94 augmented on to the capture real world video/image 90, the extent to which they move the point of aim relative to their head and also relative to the target when subjected to recoil and other factors, as best illustrated in FIGS. 12a-12c.

In yet another embodiment of the present technology, the target being aimed at can be selectively marked with a color in order to make it detectable and trackable by color-based object detection and tracking software. Once reviewed in real time or slow motion the user will be able to see a digitally superimposed trajectory of the target as it moved relative to their point of view and or point of aim.

In yet another embodiment of the present technology, the augmented video feed from the camera together with a digitally generated image could be projected in front of one or both eyes of the user in real time allowing them an enhanced reality perspective of the target.

In yet another embodiment of the present technology, the projectile being fired at the target could be augmented with a color in order to make it detectable and trackable by color based object detection and tracking software including an algorithm to predict and project trajectory. In this embodiment a suitable algorithm capable to take account the speed of the projectile together with known flight characteristics could demonstrate the trajectory of the projectile relative to a static or moving target on a frame by frame basis and demonstrate visually in real time whether sufficient lead was given to the moving target.

In yet another embodiment of the present technology, the firing of a physical projectile could be replaced with a virtual augmented reality projectile actuated by the pulling of a trigger on an unloaded weapon or simulation weapon such that the user can practice technique without the need for live firing, allowing the safe use of the present technology in an indoor environment for the purpose of training or for use in the gaming industry.

The eyewear 12 including the camera 20 can also include integrated display or projection means, a microphone and speaker, for providing additional AR environment or perception. The electronic device or display unit 60 can be, but not limited to, smart phones, smart watches, tablets, notebooks, desktop computers, laptops, DVD players, televisions digital cameras (point and shoot, single-lens reflex, video cameras, high end audio/visual gear), eyewear, drones, gimbals and other stabilizers, selfie sticks, closed circuit video monitoring system, dash cam for cars, endoscopes, microscopes, telescopes, camera and/or display embedded circuits, wearables, “Internet of Things” (IoT), and the like.

It can be appreciated that the present technology can be configured or configurable with preloaded settings, parameters, drivers, instructions, tables, databases, etc., or these can be programmed anytime.

It can further be appreciated that a broad general synopsis of an exemplary operation of the AR system has been described, which can be utilized in any embodiment of the present technology or later technology derived from the present technology.

Although the algorithms described above including any with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

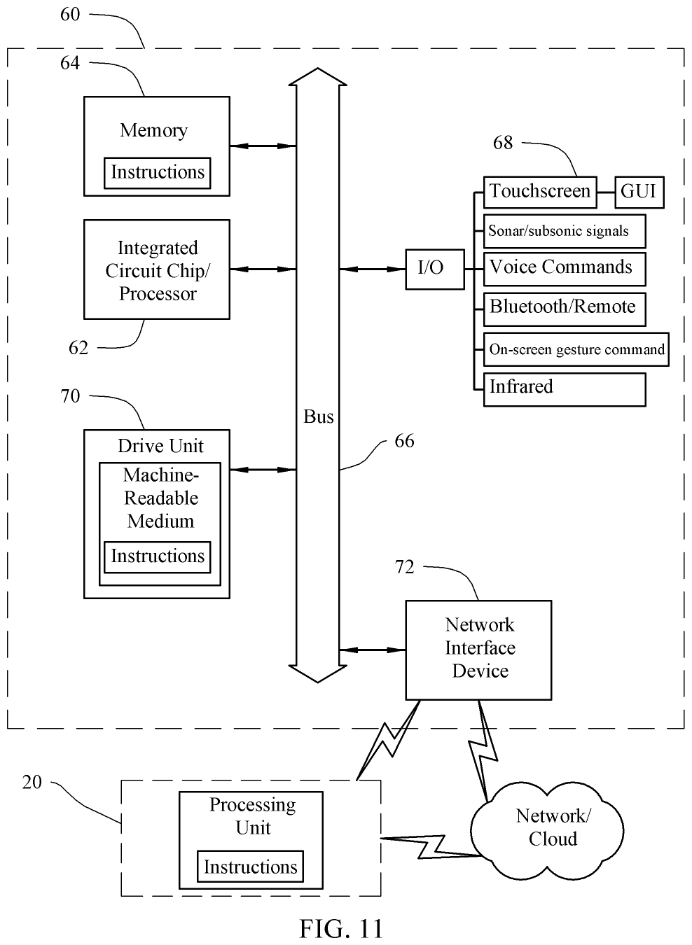

FIG. 11 is a diagrammatic representation of an embodiment of a machine in the form of a computer system of the camera 20 or the electronic device 60 of the AR system or device, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment or any other configuration as described herein with reference to any of the embodiments. The machine may any type of device described and/or shown herein in any of the accompany drawings or a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The embodiment of the computer system or electronic device 60 includes a processor or multiple processors 62 (e.g., a central processing unit (CPU), a graphics processing unit (GPU), or both), and a main and/or static memory 64, which communicate with each other via a bus 66. The computer system or electronic device 60 may further include a video display 68 (e.g., a liquid crystal display (LCD), touchscreen display). The computer system or electronic device 60 may also include an alpha-numeric input device(s) (e.g., a keyboard or virtual keyboard), a cursor control device (e.g., a mouse), a voice recognition or biometric verification unit (not shown), a drive unit 70 (also referred to as disk drive unit), a signal generation device (e.g., a speaker), and a network interface device 72. The computer system or electronic device 60 may further include a data encryption module (not shown) to encrypt data.

The drive unit 70 includes a computer or machine-readable medium on which is stored one or more sets of instructions and data structures (e.g., instructions) embodying or utilizing any one or more of the methodologies or functions described herein. The instructions may also reside, completely or at least partially, within the memory 64 and/or within the processors 62 during execution thereof by the computer system or electronic device 60. The memory 64 and the processors 62 may also constitute machine-readable media.

The instructions may further be transmitted or received over a network via the network interface device 72 utilizing any one of a number of well-known transfer protocols (e.g., Hyper Text Transfer Protocol (HTTP) etc.). While the machine-readable medium 70 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

It can be appreciated that the present technology can be configured or configurable as a complete video system utilized with the electronic device having one or more video cameras, one or more display devices, and one or more integrated circuits or processors. Alternatively, it can be appreciated that the imaging processing unit or CPU 28 of the camera 20 can be configured or configurable as a module or integrated circuit chip embedded in the electronic device, in the camera or with a component of the electronic device. Further in the alternative, the system 10 can be configured or configurable as a video data processing device such as, but not limited to, a graphics processing unit (GPU), digital signal processor (DSP), Active Server Pages (ASP), central processing unit (CPU), accelerated processing unit (APU), Application Specific Integrated Circuit (ASIC). Even further in the alternative, the system 10 can be configured or configurable as software or programming code as part of an operating system or application running on or controlling the electronic device or camera.

Not all components of the computer system or electronic device 60 are required and thus portions of the computer system or electronic device 60 can be removed if not needed, such as Input/Output (I/O) devices (e.g., input device(s)). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In other embodiments, any one or more of the method or process steps or blocks shown in the flow chart may be omitted or re ordered in relation to the other steps or blocks.

In this description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

Reference throughout this specification to “one embodiment” or “an embodiment” means that a particular feature, structure, or characteristic described in connection with the embodiment is included in at least one embodiment of the present technology. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the present technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure.

The present technology can include a wearable camera system consisting of eyewear for acquiring an image where the eyewear apparatus comprises a frame arranged to be supported on a wearer's head to extend across the head, and at least one front facing camera mounted to the frame by means of a lateral rail mount together with a least one universal tensioned three axis adjustable joint so as to allow the position and orientation of the camera axis relative to the frame and thus the wearers head to be adjustable about a vertical and horizontal axis, whereby the camera can be fixed in a particular desired position and orientation such that the camera axis and field of view can be aligned with the desired line of sight of the wearer.

While embodiments of the augmenting image method, apparatus and system have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used instead of the above-described. And although augmenting images captured using eyewear for acquiring an image presented to a viewer on an external display have been described, it should be appreciated that the augmenting image method, apparatus and system herein described is also suitable for augmenting any video feed or still image with spatially aligned virtual objects utilizing an adjustable camera.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed as being new and desired to be protected by Letters Patent of the United States is as follows:

1. A video capture system for augmenting of live video data in real time, said system comprising:
a camera configured or configurable to capture video or images of a real world scene;
a mounting rail associated with an apparatus wearable by a user; and
a universal multi-axis adjustable joint attachable to said camera and said mounting rail, said adjustable joint is configured to adjust a position and orientation of a camera axis of said camera relative to a frame of said apparatus about a vertical and horizontal axis;
wherein adjustable joint is configured to fix said camera in a desired position and orientation such that the camera axis and field of view of said camera is alignable with a desired line of sight of the user.

2. The system of claim 1, wherein said apparatus is eyewear including a frame arranged to be supported on a head of the user and to extend across the head, and said camera is a front facing camera mounted to said mounting rail that is associated with said frame.

3. The system of claim 2 further comprises a mounting member attachable to said mounting rail and said adjustable joint.

4. The system of claim 3, wherein said adjustable joint includes a first socket configured to receive a ball of said camera, and a second socket configured to receive a ball of said mounting member.

5. The system of claim 4, wherein said adjustable joint is a pair of linkage arms in space apart relation to define said first socket and said second socket when said linkage arms are assembled.

6. The system of claim 5, wherein said linkage arms are secured to said ball of said camera and said ball of said mounting member by a fastener engageable with at least one of said linkage arms.

7. The system of claim 1 further comprises an electronic device in communication with said camera to receive the captured video or images.

8. The system of claim 7, wherein said electronic device includes at least one processing unit configured to:
receive the captured video or images from said camera;
process the captured video or images to add virtual objects to create an augmented video or image; and
display the augmented video or image on a display of said electronic device or in communication with said electronic device.

9. The system of claim 8, wherein said processing unit is further configured to detect and track a real world object in the captured video or images by detecting and tracking a color applied to a particular element of the real world object such utilizing color based object detection and tracking software.

10. The system of claim 8, wherein said processing unit is further configured to selectably overlay the captured video or images viewed on said electronic device with digitally generated images comprising at least one vertical line and at least one horizontal line in combination with an array of dots or circles to provide the user with specific points of reference as a reticle whereby the user calibrates a desired position and orientation of said camera relative to a head position of the user combined with a position and orientation of a device the user focuses said camera upon relative to said virtual objects in said video or images displayed on said display visible of said electronic device.

11. A video capture system for augmenting of live video data in real time, said system comprising:
a wearable assembly comprising:
a camera configured or configurable to capture video or images of a real world scene;
a mounting rail associated with an apparatus wearable by a user; and
a universal multi-axis adjustable joint attachable to said camera and said mounting rail, said adjustable joint is configured to adjust a position and orientation of a camera axis of said camera relative to a frame of said apparatus about a vertical and horizontal axis;
wherein adjustable joint is configured to fix said camera in a desired position and orientation such that the camera axis and field of view of said camera is alignable with a desired line of sight of the user; and
an electronic device in communication with said camera to receive the captured video or images, said electronic device including at least one processing unit configured to:
receive the captured video or images from said camera;
process the captured video or images to add virtual objects to create an augmented video or image; and
display the augmented video or image on a display of said electronic device or in communication with said electronic device.

12. The system of claim 11, wherein said apparatus is eyewear including a frame arranged to be supported on a head of the user and to extend across the head, and said camera is a front facing camera mounted to said mounting rail that is associated with said frame.

13. The system of claim 12 further comprises a mounting member attachable to said mounting rail and said adjustable joint.

14. The system of claim 13, wherein said adjustable joint includes a first socket configured to receive a ball of said camera, and a second socket configured to receive a ball of said mounting member.

15. The system of claim 14, wherein said adjustable joint is a pair of linkage arms in space apart relation to define said first socket and said second socket when said linkage arms are assembled.

16. The system of claim 15, wherein said linkage arms are secured to said ball of said camera and said ball of said mounting member by a fastener engageable with at least one of said linkage arms.

17. The system of claim 11, wherein said processing unit is further configured to detect and track a real world object in the captured video or images by detecting and tracking a color applied to a particular element of the real world object such utilizing color based object detection and tracking software.

18. The system of claim 11, wherein said processing unit is further configured to selectably overlay the captured video or images viewed on said electronic device with digitally generated images comprising at least one vertical line and at least one horizontal line in combination with an array of dots or circles to provide the user with specific points of reference as a reticle whereby the user calibrates a desired position and orientation of said camera relative to a head position of the user combined with a position and orientation of a device the user focuses said camera upon relative to said virtual objects in said video or images displayed on said display visible of said electronic device.

19. A method for augmenting of live video data in real time using a video capture system, said method comprising the steps of:
adjusting a position and orientation of a camera axis of a camera relative to a frame of an apparatus about a vertical and horizontal axis utilizing a universal multi-axis adjustable joint attachable to said camera and a mounting rail associated with said apparatus wearable by the user;
fixing said camera in a desired position and orientation such that the camera axis and field of view of said camera is alignable with a desired line of sight of the user;
capturing a video or images of real world scene with said camera;
communicating the captured video or images to an electronic device;
processing the captured video or images to add virtual objects to create an augmented video or image; and
displaying the augmented video or image on a display of said electronic device or in communication with said electronic device.

20. The method of claim 19 further comprises the step of detecting and tracking a real world object in the captured video or images by detecting and tracking a color applied to a particular element of the real world object such utilizing color based object detection and tracking software.
